(19) United States
(12) Patent Application Publication
(10) Pub. No.: US 2005/0188203 A1
(43) Pub. Date: Aug. 25, 2005

(54) Method for packaging information with digitally signed software without breaking signature

(75) Inventors: Harikrishnan Bhaskaran, Dallas, TX (US); Sunil Sanakaramanchi, Plano, TX (US)

Correspondence Address: HAYNES AND BOONE, LLP, 901 MAIN STREET, SUITE 3100, DALLAS, TX, 75202, US

(73) Assignee: JP Mobile Operating L.P., Dallas, TX (US)

(21) Appl. No.: 10/782,009

(22) Filed: Feb. 19, 2004

(51) Int. Cl. H04L 9/00

(52) U.S. Cl. 713/176

(57) ABSTRACT

A method is provided for packaging software which includes a digitally signed data portion and a filename. An entity such as a software distributor provides information which is to be conveyed to the end user with a software package. The information in encoded and then added to the name of the file without altering the digitally signed data portion of the file. In this manner, information is added to the file data portion without breaking the digital signature. The software package thus created is sent to the end user by the retail channel or by downloading to the user's computing device. Once received by the user's computing device, the information is decoded and displayed to the user. The data portion of the file is then installed and executed.

### BACKGROUND

The disclosures herein relate generally to the distribution of software and more particularly to the distribution of software which is digitally signed.

Software packages are normally distributed via the Internet or world wide web as downloadable executable files. Web servers that hold these downloadable executable files are typically not as secure as the software developer's development system on which the software was originally packaged. Moreover, the web server where the downloadable executable file is stored for distribution can even be in the control of a reseller or third party. To detect and avoid alterations to the software, the software package which includes the executable file is typically digitally signed by the developer before it leaves the developer's premises. The end user's computer by using “browser” software can now verify the digital signature and make sure the software package has not been altered by the distributor or others in the distribution chain downstream from the developer. A significant disadvantage of this digital signature approach is that the distributor is unable to add anything to the signed software package even if the change is intended to benefit the user. For example, the distributor may want to record a customer-support telephone number, an order-number, or a custom software setting, along with the software. Any changes made to the contents of the software package or file will destroy the package's signature.

One current technique for including additional information with a software package download is to provide the user with a confirmation page that the user is expected to print when the software package in installed. The confirmation page can simply be a web page that is presented to the user as soon as the user has finished downloading the software. Alternatively, the confirmation page may take the form of an additional file placed on the same media disk/CD/DVD as the original software if there is physical shipment of the software package involved. The confirmation page can include such information as the order number, invoice number or a confirmation number. Unfortunately these approach have disadvantages. For example, although the user has saved the software on the hard disk of the user's computer, the user may either forget to print the confirmation page/receipt or may even lose it while transferring it to another media or computer. Moreover, the information added by the distributor is separate and disconnected from the software. Some users are more likely to look for support information under an “About” screen of a software package than in a separate file/printed paper.

Another technique for including additional information with a software package is repacking the existing software within another self-extracting or regular compressed file. Although the resulting executable file can then be signed by the distributor, this “package within a package” approach has many disadvantages. First, the second level signing process is necessarily automated and this defeats the whole purpose of digital signatures. Second, the user is now put in the position of needing to trust two companies or two systems, namely the developer and the distributor. And finally, if the outer executable file is not signed, this compromises the benefit of signing the inner executable file.

What is needed is a more efficient way to add information to a software package without destroying its authentication or digital signature.

### SUMMARY

Accordingly, in one embodiment, a method is disclosed for packaging software. The method includes providing a software package including a file having a name portion and a data portion. The data portion of the file is digitally signed for authentication purposes. Information, such as user settings, helpful contact numbers, and software configuration information is supplied for inclusion in the software package. The name portion of the file is modified to include the information; however, the digital signature of the data portion is not broken. In one embodiment, the software distributor or other reseller modifies the filename as just described before the software package is sent to the end user or elsewhere in the downstream software distribution channel.

A principal advantage of the embodiments disclosed herein is that an entity other than the software developer can add valuable information to a software package without destroying the digital signature of a file in the software package.

### BRIEF DESCRIPTION OF THE DRAWINGS

FIG. 1 is a flow diagram of the disclosed method for communicating information along with a digitally authenticated software package.

FIG. 2 is a flow diagram of another method for communicating information along with a digitally authenticated software package.

FIG. 3 is a flow chart showing the steps in the disclosed software packaging process from software developer, through the distributor(s) to the end user.

### DETAILED DESCRIPTION

The present disclosure provides a unique method for adding information to a digitally signed software package. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well-known elements are presented without detailed description in order not to obscure the present invention in unnecessary detail. For the most part, details unnecessary to obtain a complete understanding of the present disclosure have been omitted inasmuch as such details are within the skills of persons of ordinary skill in the relevant art.

For purposes of this document, a developer/vendor is a person, company or other entity that develops software and is responsible for the executable code in the software The developer/vendor digitally signs the software package including the executable file to assure others that the package is authentic. A distributor is an entity that receives the software package for the purpose of reselling or otherwise conveying the package to other downstream distributors or to the end user. A distributor can be any entity in the channel from the developer/vendor to the end user that is involved in the process of delivering the software package to the end user. For example, a distributor can be an entity that sells the software to other distributors or sells the software directly to the end user. A distributor can also be a web distribution system owned by the developer/vendor, a distributor or a third party.

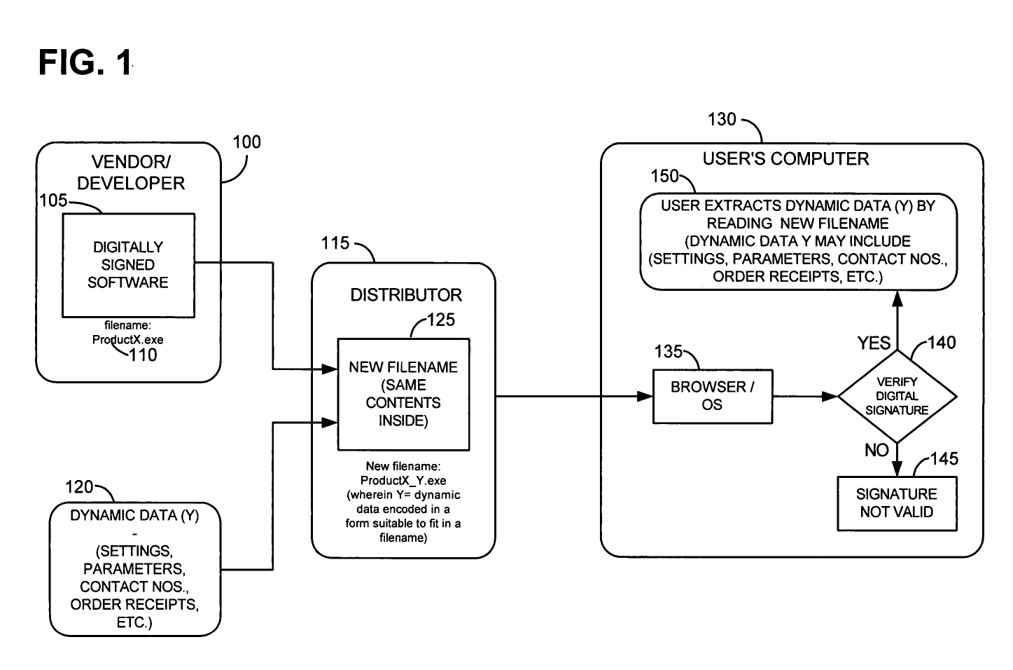

One embodiment of the disclosed technology is shown in FIG. 1 which is a flow diagram depicting a method of packaging information in the filename of a digitally signed software package as it travels in the distribution channel between the vendor/developer of a software package and the end user. A software package including an executable computer program file is written at vendor/developer's facility 100. The software package is signed or authenticated using a conventional digital signature algorithm thus producing a digitally signed software package 105 as shown. In this example, the filename 110 is “ProductX.exe” which represents a digitally signed executable file.

The digitally signed software package 105 with file name “ProductX.exe” is then sent to a distributor 115. It is assumed that the distributor desires to add dynamic data 120 to the digitally signed software package 105 before distributing the package to downstream distributors or the ultimate end user. This dynamic data may include for example contact phone numbers, settings, parameters, order receipts as well as other information such as software configuration information which is helpful to the end user or others. At the facility of distributor 115 the filename 110 of the digitally signed software package 105 is changed while the data, namely the digitally signed portion of the file, is left unchanged. More specifically, the filename is changed to a new filename, namely ProductX_Y.exe wherein Y=dynamic data 120. All data to be passed downstream in the distribution channel are encoded in the filename. For example, the dynamic data 120, namely Y, may be a tech support telephone number, 1-800-123-4567, that distributor 115 desires to pass along with software package 105. In this case, the file name becomes ProductX_{—}1-800-123-4567. The digitally signed software of the package remains unchanged. Thus, the digital signature is not broken by changing the filename to incorporate the dynamic data as just described. The filename is not part of the conventional digital signature algorithms in use today.

The new file 125 thus formed by modifying the filename of the software package is sent downstream in the distribution channel until it reaches the end user's computer 130. New file 125 is received by the operating system and browser 135 of user's computer 130. Computer 130 then performs a test at decision block 140 to verify the integrity of the digital signature of the data portion of the file. If the digital signature is invalid then the user is notified that the signature of the software package is invalid as per block 145. However, if the digital signature of the software package is valid, then process flow continues to read new filename block 150. In this embodiment wherein Y is text which is added to the original filename to create the new filename, the new filename is presented for viewing to the user of computer 130. The user then reads the new filename to extract this text which may include dynamic data such as settings, parameters, contact numbers, order receipts, etc.

In more detail, a message such as the tech support phone number given by the character string “Support18001234567 can be included in the new filename in the following manner. First, allowed characters are decided upon, for example, a-z, A-Z, 0-9,:, &. Every other character in data is replaced with ‘-XY’ where ‘-’ is the delimiter and XY are the two hexadecimal digits of ASCII code of a particular character. Any occurrence of ‘-’ itself in the character string is also represented by the corresponding ASCII code for that character. In the subject example wherein the original filename is “X.exe” and the dynamic data is the character string “Support18001234567”, the resultant new filename would be “X_Support18001234567”. From this, the user would be able to readily ascertain the support phone number when the new filename is displayed on the user's screen.

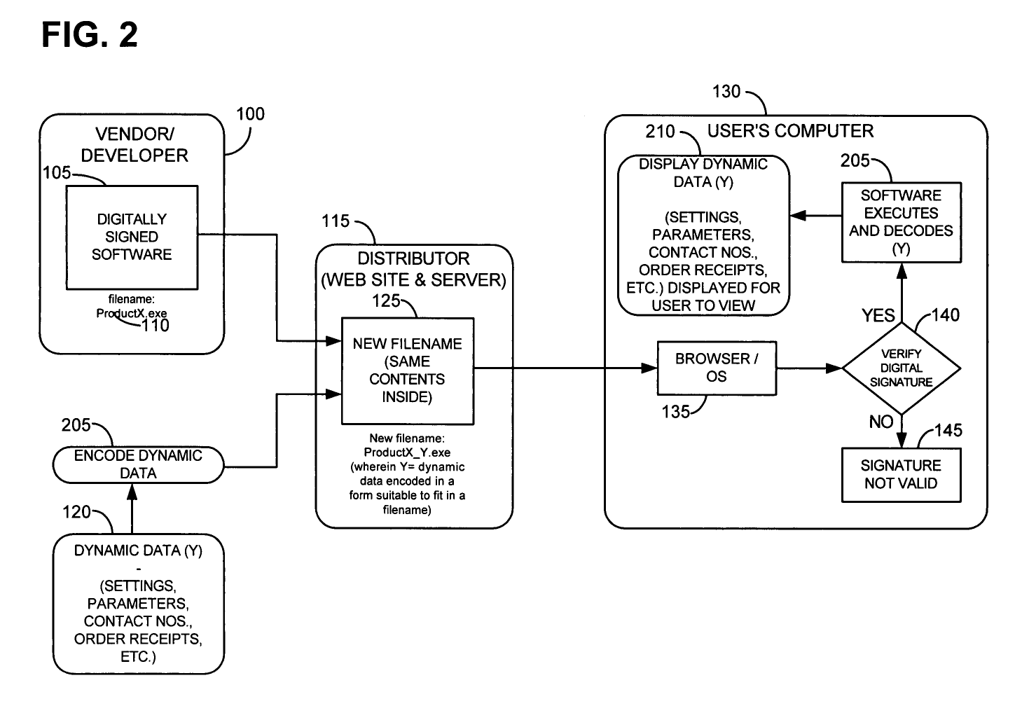

Other embodiments are possible wherein dynamic data Y are encoded into the filename to form the new filename such as the embodiment illustrated in FIG. 2. The components of the distribution chain flow diagram of FIG. 2 are similar to the components in the distribution chain of FIG. 1 with like numbers being used to designate like components. It is noted that conventional digital signature or authentication algorithms act on a file's data portion as opposed to its filename. The digitally signed data portion typically includes executable code. In FIG. 2 dynamic data 120 are shown being encoded by an encoder 200. In one embodiment, this encoding operation is conveniently carried out in a conventional desktop or other available general purpose computing system located at the distributor's facilities. In this example, Y=the character string “Support18001234567” which is to be encoded in the filename. This data is represented as name value pairs (K,V) where K is the key and V is the value. Series of name value pairs are separated by a separator ‘&’ (ampersand). An alternate implementation may use a different letter. The key and value are separated by ‘;’. The entire character string “Support18001234567” is encoded in base 64 or other custom encoding so that the user would immediately see it. The encoding may done for two reasons, namely: (1) If the data Y is encoded, it may be possible to represent it using fewer bytes than if it were not encoded. This will permit keeping the filename small enough that is does not cause problems in those computers that cannot handle long filenames (for example, more than 128 or 256 characters). The encoding will depend on the data that needs to be included. Filenames generally cannot have 8-bit characters and may be part of the data that needs to be included. In this case the 8-bit characters are converted to 7-bit characters and also restricted to the set of characters allowed—a-z, A-Z, 0-9 etc. In one embodiment, Base64 is used to encode the characters. However, Base64 increases the data length. Hence the data is compressed using a scheme such as Lempel Ziv Welch (LZW) or Deflate and then encoded using Base64. A combination of compression and 8-bit to 7-bit conversion (base64) provides acceptable results. It is noted however that the encoding mechanism may be different and depends on the type of data that needs to be included by the distributor and supported by the vendor. (2) Sometimes the distributor may not want the user to see the support number or to possibly infer the wrong number by merely looking at the filename. For example, Support218001234567.exe may be interpreted by the user as 218-001-2345 or 1800-123-4567. Instead of confusing the user, the vendor/distributor may want to simply encode it, make it illegible and then present it to the user in an About screen. Although the data is public and cannot be encrypted, it can be more ‘user friendly’ to leave the data encoded in the filename and cause the user's computer 130 to display or process the data during or after the installation of the software package. This approach is desirable if the data includes software settings such as software configuration information which wouldn't immediately make sense to the user of computer 130.

In an example, X_Y.exe where X is the original filename and Y=“Purchased from XYZ Inc. on Jan. 1, 2003, Serial No. 8678502, Privilege Level 3” is the dynamic data and “Privilege Level 3” is a software setting for the software included in the software package, the dynamic data can be encoded by encoder 205 which uses any of several different encoding methods including character by character substitution. This encoding of the dynamic data Y=“Purchased from XYZ Inc. on Jan. 1, 2003, Serial No. 8678502, Privilege Level 3” results in encoded dynamic data for example such as “dkjsdiu37634987234kjhasd762lkdyoek45thercg975boownfd 2bm4b9′xqhtuor3bsob4”. The new filename is thus X_Y=X_dkjsdiu3763498 7234kjhasd762lkdyoek45thercg975boownfd2bm4b9′xqhtuor3bsob4”. Distributor 115 distributes the resultant software package 125, namely the original package which has been renamed to X_Y. This software package with the new filename and original data portion is distributed to the user of user's computer 130. The software package is then loaded by the user on computer 130 and is received by the computer's operating system 135. Browser or other software verifies the digital signature of the data portion or file in the software package. It should be noted that the data portion has not changed if the software package is authentic. Rather, the filename has changed with the addition of the encoded information. If the digital signature of the file or data portion of the software package is not verified, then a message “signature not valid” is displayed to the user as per decision block 145. However if the digital signature of the file or data portion of the software package is found to be valid at decision block 145, then appropriate decoding software is executed on computer 130 at decoder block 205 to decode the dynamic data Y contained in the new filename X_Y as per decode block 205. The decoding algorithm used in decoder block 205 corresponds to the reverse of the encoder algorithm employed for encoding block 200. For example, if letter swapping was used as the encoding algorithm for encoder block 205, then letter unswapping would be used as the decoder algorithm for decoder block 205. After the filename is decoded, the information in the filename is displayed to the user as per display block 215.

In another embodiment, the file including the data portion and filename can be wrapped in another file by the at the distributor's site. This can be helpful in adding labels of distributor specific information or helps the distributor in identifying software in the distributor's inventory. In one approach, the data portion, namely the exe file, is wrapped in a zip file which includes a zip file comment holding the version, platform, environment, distribution channel, customer support information and other helpful details regarding the software package. The files thus wrapped are presented to the end user, for example when the end user logs onto a server at the distributor's site 115. The end user's information, such as software settings, are encoded as described earlier and the distributor's server sends signed exe bytes, namely the data portion, by extracting them from the wrapper. The filename including encoded information is also presented to the end user by the distributor's server.

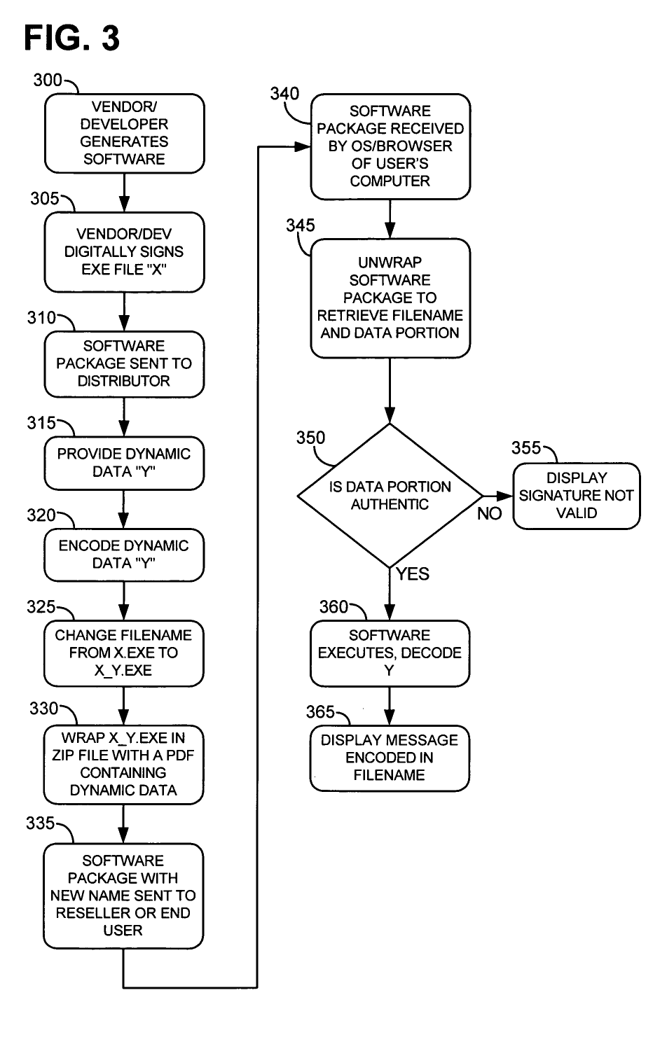

FIG. 3 is a more detailed flow diagram for an embodiment wherein the data portion of the file with its filename encoded with data are wrapped together during the distribution process. A developer or vendor develops software as per block 300. The software includes a file data portion with a given filename. The developer/vendor uses an authentication algorithm to digitally sign the file data portion as per block 305. The software package is then sent to a distributor or reseller as per step 310. Dynamic data is then identified to be transmitted in the filename of a file in the software package as per block 315. The term dynamic is used here to describe the data as that is to be conveyed in the modified filename. This data is dynamic in the sense that it may be not be known until after a purchase of the software that is to be downloaded by the user and the data may vary from user to user as the software is downloaded. The dynamic data is then encoded using one of the methods earlier described as per block 320. The filename of the data portion of the file is then changed to incorporate the encoded dynamic data as per block 325. The new filename and the file data portion are then wrapped together by using techniques such as by creating a zip file as per block 330. The zipped software package with its new name is then sent to a downstream reseller or to the end user as per block 335. The software package can be sent to the end user's computer by electronic commerce, for example, by the user logging onto the distributor's server computer site and downloading the software package as per block 335. Alternatively, the software package can be sent to the user by retail sale or by transmission through the mail or courier service. The software is then loaded on the end user's computer where it is received by the user's operating system or web browser as per block 340. The software package is unwrapped as per block 345 to retrieve the modified filename and file data portion. A test is then conducted at decision block 350 to determine if the file data portion is authentic. If the file data portion is invalid or unauthentic, then a corresponding “file invalid” message is displayed on the display of the user's computer as per block 355. However, if the file data portion is found to be authentic, then the file data portion executes and is installed on the user's computer and the filename is decoded as per block 360. The decoded filename contains the original dynamic data or information that is then displayed to the user on the display of the user's computer system as per block 365. If the dynamic data contained configuration information for the executable content of the data portion, than that decoded dynamic data can be used in step 360 to configure the software as it installs on the end user's computer device.

Portable computer users such as those using personal digital assistants (PDA's), so-called smart phones, as well as laptop, notebook or other portable computing devices can directly download and install software from a distributor's website on the world wide web or Internet. However, some limitations may apply during such downloads and installation. Installers are special software package files which are interpreted by the operating system of the end user's computer system. The installer itself generally can not contain custom executable code. Thus, the file renaming approach describe above may not always work for such devices. Some less experienced end user's may find it difficult to logon to the software distributor's website to download and install a custom software package created for that user. Some user's still have difficulty performing many computer tasks. For these reasons, the distributor's server computer includes the details inside a platform specific package. The software package is regenerated on the distributor's server based on the user's setting and is then downloaded to the user's portable computing device. Upon the user's request when the user's portable computing device is logged onto the distributor's web site or server, the server will send a special URL to the portable computing device that includes all information required to identify the user. This URL can be sent as either an email, an simple message service (SMS) message, a text page, or any such text delivery mechanism available to the portable computing device. Depending on the capabilities of the particular portable computing device, the user can directly click on the URL or copy the URL to the browser of the portable computing device. Once the distributor's server receives a request directly from the browser of the user's portable computing device, a platform specific installer package as constructed on the server is sent to the user's portable computing device as a response to a browser request. The package includes the user's settings and any additional information which the distributor desires to transmit to the user in the software package. The user's portable computing device then downloads the installer package. The operating system of the user's portable computing device will then detect the downloaded file as an installer package and execute it as appropriate.

Some typical uses of the disclosed file packaging and distribution technology are now discussed. Advantageously, the disclosed method can be used to provide the software customer with confirmation numbers, customer support numbers, invoices and receipts during online download of software. This information is encoded and stored in the altered file name of the software package without changing the software file data portion and thus avoids breaking its digital signature. Moreover, the modified filename of the software package can be used to convey user settings required for the software in the software package to properly function. For example, an email client such as Microsoft's Outlook Express downloaded from an Internet service provider's (ISP's) web server can be automatically configured with the IMAP, POP3 or SMTP server names appropriate for the mail server supported by that ISP. Again, this information is encoded in the modified file name of the software package. The disclosed methodology can also be applied to automatic software registration. In this scenario, the software package once installed on the user's computer would post back user details (name, address and other information) to the vendor's or developer's web site. For example, a developer/vendor having hundreds of distributors can delegate responsibility for all software registrations to the distributors. The information which the distributor would add to the filename of the software pack is the URL to which the user's registration details should be sent. Each distributor would encode additional data in such a way that the URL points to their own web site for purposes of handling software registration. In this scenario, the registration details from a particular user would be sent to the distributor from which the software was originally downloaded.

The above described method of encoding information in the filename of the software package can also be used to selectively enable and disable features of the software depending on settings chosen by the user on the distributor's website. For example, a user who pays for just a few features will have different data encoded in the filename than a user who paid for all features. Upon installation by the user, the software looks at the feature set specified in the filename and installs and activates those features. In other words, the software can now decide which features to install based on the settings retrieved from the decoded filename. In one embodiment, the encoded data in the filename is encrypted to prevent the user from improperly manipulating the data to install features for which the user has not paid. Without this technique, the developer or vendor must build numerous software packages for each combination of features or restrict features by use of a license file as is common today.

Advantageously, the disclosed methodology and apparatus provides great flexibility in conveying information to the user of software packages without breaking the digital signature or authenticity of the files in the software package.

Although illustrative embodiments have been shown and described, a wide range of modification, change and substitution is contemplated in the foregoing disclosure. For example, the messages processed by the disclosed system can be text mail or voice mail messages. Some features of an embodiment may be employed without a corresponding use of other features. Accordingly, it is appropriate that the appended claims be construed broadly and in manner consistent with the scope of the embodiments disclosed herein.

1. A method of packaging software comprising:
providing a software package including a file having a name portion and a data portion;
digitally signing the data portion of the file for authentication purposes;
supplying information for inclusion in the software package; and
modifying the name portion of the file to include the information.

2. The method of claim 1 including encoding the information prior to modifying the name portion of the file.

3. The method of claim 1 including receiving the software package by a user's computing device.

4. The method of claim 3 including downloading, by the user's computing device, the software package from a software package distribution site.

5. The method of claim 4 including decoding, by the user's computing device, the received software package to provide decoded information.

6. The method of claim 5 including installing the received software package on the user's computing device.

7. The method of claim 6 including displaying the decoded information on the user's computing device for observation by the user.

8. The method of claim 1 wherein the information dynamically varies from software user to software user.

9. The method of claim 1 including wrapping the name portion and the data portion together to form a wrapped software package.

10. The method of claim 9 including providing the wrapped software package to the user's computing device.

11. The method of claim 10 including unwrapping the wrapped software package by the user's computing device.

12. The method of claim 1 wherein the information includes user settings.

13. The method of claim 12 wherein the information includes software configuration information.

14. The method of claim 1 wherein the data portion is an executable file.

15. A method of packaging software comprising:
receiving, by a distributor, software including a file having a name portion and a digitally signed data portion;
providing, by the distributor, information to be included with the software to form a software package; and
modifying the name portion of the file to include the information.

16. The method of claim 15 including encoding, by the distributor, the information prior to modifying the name portion of the file.

17. The method of claim 15 including receiving, by a user's computing device, the software package.

18. The method of claim 17 including downloading, by the user's computing device, the software package from a software package distribution site.

19. The method of claim 18 including decoding, by the user's computing device, the received software package to provide decoded information.

20. The method of claim 19 including installing the received software package on the user's computing device.

21. The method of claim 19 including displaying the decoded information on the user's computing device for observation by the user.

22. The method of claim 15 wherein the information dynamically varies from software user to software user.

23. The method of claim 15 including wrapping the name portion and the data portion together to form a wrapped software package.

24. The method of claim 23 including providing the wrapped software package to the user's computing device.

25. The method of claim 24 including unwrapping the wrapped software package by the user's computing device.

26. The method of claim 15 wherein the information includes user settings.

27. The method of claim 15 wherein the information includes software configuration information.

28. The method of claim 15 wherein the data portion is an executable file.
